(19) United States
(12) Patent Application Publication
(10) Pub. No.: US 2025/0200751 A1
(43) Pub. Date: Jun. 19, 2025

(54) TRAINING A POINT CLOUD PROCESSING MODEL USING A COMPUTER VISION MODEL

(71) Applicant: Waymo LLC, Mountain View, CA (US)

(72) Inventors: Jingwei Ji, Sunnyvale, CA (US); Tianyi Cai, Mountain View, CA (US); Christoph Sprunk, Mountain View, CA (US); Yin Zhou, San Jose, CA (US); Wudi Wang, Walnut Creek, CA (US); Roshni Cooper, Cupertino, CA (US)

(21) Appl. No.: 18/542,327

(22) Filed: Dec. 15, 2023

(51) Int. Cl. G06T 7/10; G06T 3/40

(52) U.S. Cl. CPC G06T 7/10; G06T 3/40; G06T 2207/10028; G06T 2207/20021; G06T 2207/20081; G06T 2207/20084

(57) ABSTRACT

Methods, systems, and apparatus, including computer programs encoded on computer storage media, for obtaining a training data set comprising a plurality of training point clouds and, for each training point cloud, a corresponding set of images; and training, on the training data set, a point cloud processing neural network that is configured to process an input point cloud comprising a plurality of points to generate a respective feature for each of the plurality of points, the training comprising, using, as target features for the point cloud processing neural network, features generated by processing the corresponding sets of images using a pre-trained computer vision neural network.

### BACKGROUND

This specification relates to processing point cloud data using neural networks.

Neural networks are machine learning models that employ one or more layers of nonlinear units to predict an output for a received input. Some neural networks include one or more hidden layers in addition to an output layer. The output of each hidden layer is used as input to or more other layers in the network, i.e., one or more other hidden layers, the output layer, or both. Each layer of the network generates an output from a received input in accordance with current values of a respective set of parameters.

### BRIEF DESCRIPTION OF THE DRAWINGS

FIG. 1 shows a block diagram of an example system.

FIG. 2 shows a block diagram of an example training system.

FIG. 3 shows an example training pipeline.

FIG. 4 is a flow diagram of an example process for training a point cloud processing neural network.

FIG. 5 is a flow diagram of an example process for training a point cloud processing neural network.

FIG. 6 is flow diagram of an example process for generating a respective target feature for each of a plurality of points in a point cloud.

Like reference numbers and designations in the various drawings indicate like elements.

### DETAILED DESCRIPTION

This specification describes a system implemented as computer programs on one or more computers in one or more locations that trains a point cloud processing neural network to process point cloud data representing a sensor measurement of a scene captured by one or more sensors. For example, the one or more sensors can be sensors of an autonomous vehicle, e.g., a land, air, or sea vehicle, and the scene can be a scene that is in the vicinity of the autonomous vehicle.

In particular, the system trains the point cloud processing neural network using target features generated by a pre-trained computer vision neural network. Using the pre-trained computer vision neural network can leverage camera information during training to enhance the accuracy of the point cloud processing neural network after training.

In contrast to existing approaches for training point cloud processing neural networks, the described techniques use a pre-trained computer vision neural network to generate target features for the point cloud neural network.

For example, existing approaches for processing point cloud data suffer from a lack of accuracy due to over filtering. Filtering smooths noise in a point cloud by removing or reducing data associated with noise. Over-filtering can occur when points associated with objects are incorrectly identified as noise. For example, as a result of this over-filtering, an autonomous vehicle may fail to properly detect an object e.g., a fallen fence or a metal grate that is mistaken by a perception subsystem of the autonomous vehicle as crosstalk or weather phenomenon (i.e. rain), and this can adversely affect the operation of the autonomous vehicle.

In particular, using only point cloud training data when training the point cloud processing neural network can make it difficult to accurately distinguish objects that may have holes (hollow portions) in them (i.e., a chain link fence, a net, etc.) from noise or weather.

By making use of a pre-trained computer vision neural network that can leverage camera information during training, the point cloud processing neural network can generate accurate features from a point cloud. This allows for the point cloud processing neural network to generate task outputs, e.g., object detection or object classification outputs, that are more accurate and have higher precision than conventional approaches. The pre-trained computer vision neural network can be trained using text. Training the computer vision neural network on text allows the computer vision neural network to semantically identify and provide accurate context for objects that are present in a point cloud.

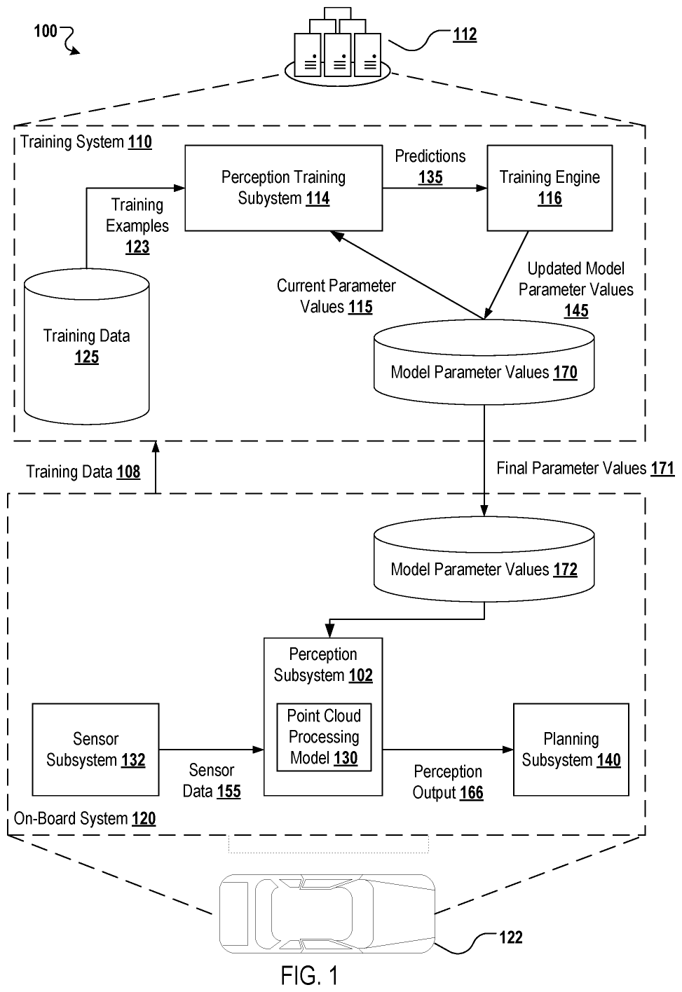

FIG. 1 is a diagram of an example system 100. The system 100 includes an on-board system 120 and a training system 110.

The on-board system 120 is physically located on-board a vehicle 122. The vehicle 122 in FIG. 1 is illustrated as an automobile, but the on-board system 120 can be located on-board any appropriate vehicle type.

In some cases, the vehicle 122 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 122 can autonomously apply the brakes if a prediction indicates that a human driver is about to collide with another vehicle. As another example, the vehicle 122 can have an advanced driver assistance system (ADAS) that assists a human driver of the vehicle 122 in driving the vehicle 122 by detecting potentially unsafe situations and alerting the human driver or otherwise responding to the unsafe situation. As a particular example, the vehicle 122 can alert the driver of the vehicle 122 or take an autonomous driving action when an obstacle is detected, when the vehicle departs from a driving lane, or when an object is detected in a blind spot of the human driver.

The on-board system 120 includes a sensor subsystem 132 which enables the on-board system 120 to “see” the environment in a vicinity of the vehicle 122. The sensor subsystem 132 includes one or more sensors, some of which are configured to receive reflections of electromagnetic radiation from the environment in the vicinity of the vehicle 122. For example, the sensor subsystem 132 can include one or more laser sensors (e.g., LIDAR sensors) that are configured to detect reflections of laser light. As another example, the sensor subsystem 132 can include one or more radar sensors that are configured to detect reflections of radio waves. As another example, the sensor subsystem 132 can include one or more camera sensors that are configured to detect reflections of visible light.

The sensor subsystem 132 repeatedly (i.e., at each of multiple time points) uses raw sensor measurements, data derived from raw sensor measurements, or both to generate sensor data 155. The raw sensor measurements indicate the directions, intensities, and distances travelled by reflected radiation. For example, a sensor in the sensor subsystem 132 can transmit one or more pulses of electromagnetic radiation in a particular direction and can measure the intensity of any reflections as well as the time that the reflection was received. A distance can be computed by determining the time which elapses between transmitting a pulse and receiving its reflection. Each sensor can continually sweep a particular space in angle, azimuth, or both. Sweeping in azimuth, for example, can allow a sensor to detect multiple objects along the same line of sight.

In particular, the sensor data 155 includes point cloud data that characterizes the latest state of an environment (i.e., an environment at the current time point) in the vicinity of the vehicle 122. A point cloud is a collection of data points defined by a given coordinate system. For example, in a three-dimensional coordinate system, a point cloud can define the shape of some real or synthetic physical system, where each point in the point cloud is defined by three values representing respective coordinates in the coordinate system, e.g., (x, y, z) coordinates. As another example, in a three-dimensional coordinate system, each point in the point cloud can be defined by more than three values, with three of the values representing coordinates in the coordinate system and the additional values each representing a property of the point of the point cloud, e.g., an intensity of the point in the point cloud. Point cloud data can be generated, for example, by using LIDAR sensors or depth camera sensors that are on-board the vehicle 122. For example, each point in the point cloud can correspond to a reflection of laser light or other radiation transmitted in a particular direction by a sensor on-board the vehicle 122.

The on-board system 120 can provide the sensor data 155 generated by the sensor subsystem 132 to a perception subsystem 102 for use in generating perception outputs 166.

The perception subsystem 102 implements components that perform a perception task, e.g., that identify objects within a vicinity of the vehicle or classify already identified objects or both.

The components include one or more machine learning models that have been trained to compute a desired prediction when performing a perception task.

For example, the perception output 166 may be a classification output that includes a respective object score corresponding to each of one or more object categories, each object score representing a likelihood that the input sensor data characterizes an object belonging to the corresponding object category.

As another example, the perception output 166 can be an object detection output that includes data defining one or more bounding boxes in the sensor data 155, and optionally, for each of the one or more bounding boxes, a respective confidence score that represents a likelihood that an object belonging to an object category from a set of one or more object categories is present in the region of the environment shown in the bounding box.

As another example, the perception output 166 can be a segmentation output that assigns to some or all of the pixels in the point cloud a respective score for each of a set of object categories that represents a likelihood that the point is a measurement of an object from that object category.

Examples of object categories include fences, nets, grates, vehicle protrusions, pedestrians, cyclists, or other vehicles near the vicinity of the vehicle 122 as it travels on a road.

The perception subsystem includes a point cloud processing model 130. The point cloud processing model 130 is configured to process an input point cloud to generate a respective feature for each point in the point cloud. After processing the input point cloud to generate a respective feature for each point in the point cloud, the point cloud processing model 140 is also configured to process the respective features to generate a prediction for a machine learning task e.g., object detection, trajectory prediction, object tracking, etc.

The on-board system 120 can provide the perception outputs 166 to a planning subsystem 140. When the planning subsystem 140 receives the perception outputs 166, the planning subsystem 140 can use the perception outputs 166 to generate planning decisions which plan the future trajectory of the vehicle 122. The planning decisions generated by the planning subsystem 140 can include, for example: yielding (e.g., to pedestrians identified in the perception outputs 132), stopping (e.g., at a “Stop” sign identified in the perception outputs 132), passing other vehicles identified in the perception outputs 166, adjusting vehicle lane position to accommodate a bicyclist identified in the perception outputs 166, slowing down in a school or construction zone, merging (e.g., onto a highway), and parking. The planning decisions generated by the planning subsystem 140 can be provided to a control system of the vehicle 122. The control system of the vehicle can control some or all of the operations of the vehicle by implementing the planning decisions generated by the planning system. For example, in response to receiving a planning decision to apply the brakes of the vehicle, the control system of the vehicle 122 may transmit an electronic signal to a braking control unit of the vehicle. In response to receiving the electronic signal, the braking control unit can mechanically apply the brakes of the vehicle.

In order for the planning subsystem 140 to generate planning decisions which cause the vehicle 122 to travel along a safe and comfortable trajectory, the on-board system 120 must provide the planning subsystem 140 with high quality perception outputs 166.

The on-board machine learning subsystem 134 can also use the sensor data 155 to generate training data 108. The training data 108 can be used to train the point cloud processing model 130. The on-board system 120 can provide the training data 108 to the training system 110 in offline batches or in an online fashion, e.g., continually whenever it is generated.

The training system 110 trains the point cloud processing model 130 that will later be deployed on the vehicle 122.

The training system 110 includes a machine learning training subsystem 114 that can implement the operations of the point cloud processing model 130 that is configured to process an input point cloud to generate a respective feature for each point in the point cloud. The point cloud processing model can additionally be configured to process the respective features for each of the points to generate a task prediction for a machine learning task. The machine learning training subsystem 114 includes a plurality of computing devices having software or hardware modules that implement the respective operations of a machine learning model, e.g., respective operations of each layer of a neural network according to an architecture of the neural network.

The machine learning training subsystem 114 can compute the operations of the point cloud processing model, e.g., the operations of each layer of a neural network, using current parameter values 115 stored in a collection of model parameter values 170. Although illustrated as being logically separated, the model parameter values 170 and the software or hardware modules performing the operations may actually be located on the same computing device or on the same memory device.

The machine learning training subsystem 114 can receive training examples 123 as input. The training examples 123 can be training data 125 that is stored in a database. Each training example includes a training point cloud and a corresponding set of images. The machine learning training system can also include a pre-trained computer vision model that generates target features for the point cloud processing model by processing the corresponding sets of images. Optionally, each training example can include a respective ground truth label for a machine learning task.

The machine learning training subsystem 114 can generate, for each training example 123, error predictions 135. Each error prediction 135 represents an estimate of an error between a ground truth output for a point and a target feature generated by the point cloud processing model 102 that is being trained. A training engine 116 analyzes the error predictions 135 and compares the error predictions to the labels in the training examples 123 using a loss function, e.g., a classification loss or a regression. The training engine 116 then generates updated model parameter values 145 by using an appropriate updating technique, e.g., stochastic gradient descent with backpropagation. The training engine 116 can then update the collection of model parameter values 170 using the updated model parameter values 145.

After training is complete, the training system 110 can provide a final set of model parameter values 171 to the on-board system 120 for use in making fully autonomous or semiautonomous driving decisions. For example, the training system 110 can provide a final set of model parameter values 171 to the cloud point processing model 130 that runs in the on-board system 120. The training system 110 can provide the final set of model parameter values 171 by a wired or wireless connection to the on-board system 120.

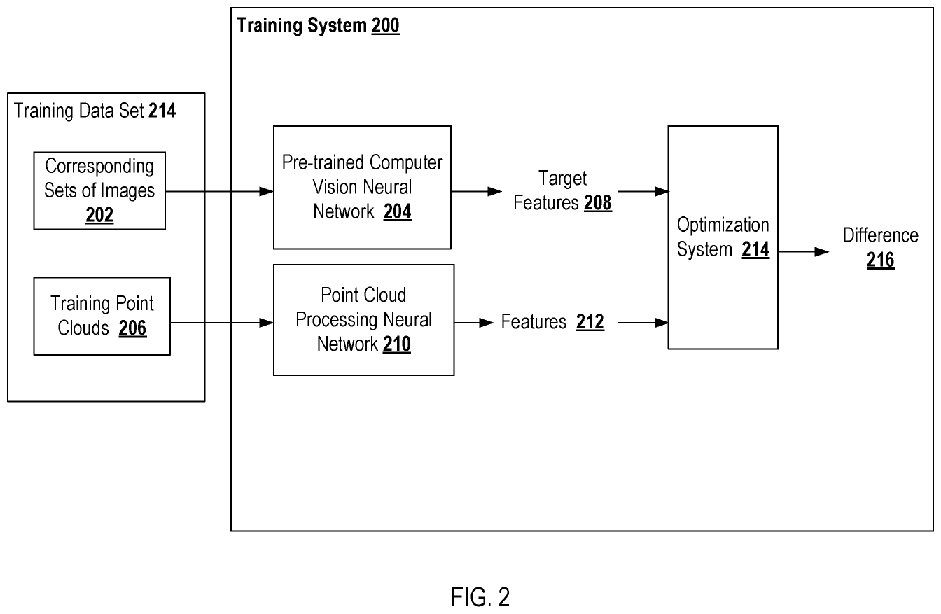

Training the cloud point processing model 130 is described in more detail below with reference to FIGS. 2-6.

FIG. 2 shows an example training system 200. The training system 200 includes a pre-trained computer vision neural network 204, a point cloud processing neural network 210, and an optimization system.

The training system 200 receives a training data set 214. The training data set 214 includes a plurality of training point clouds 206 and, for each training point cloud, a corresponding set of images 202. Each training point cloud 206 can represent a sensor measurement of a scene captured by one or more sensors.

Each training point cloud 206 in the training set 214 is a collection of data points defined by a given coordinate system. For example, in a three-dimensional coordinate system, a point cloud can define the shape of some real or synthetic physical system, where each point in the point cloud is defined by three values representing respective coordinates in the coordinate system, e.g., (x, y, z) coordinates. As another example, in a three-dimensional coordinate system, each point in the point cloud can be defined by more than three values, wherein three values represent coordinates in the coordinate system and the additional values each represent a property of the point of the point cloud, e.g., an intensity of the point in the point cloud. Point cloud data can be generated, for example, by using LIDAR sensors or depth camera sensors. For example, each point in the point cloud can correspond to a reflection of laser light or other radiation transmitted in a particular direction by a sensor a vehicle.

The corresponding set of images 202 for a training point cloud 206 can include images captured by one or more camera sensors aboard the vehicle e.g., an SVC camera, an RGB camera etc. Each set of images can include one or more images of the scene surrounding the vehicle at a point in time. In some examples, the images in the sets of images can be captured by multiple cameras that each capture an image of respective regions of the environment at the given point in time. That is, the field of view of each camera can span a different portion of the environment in the vicinity of the autonomous vehicle.

For each training point cloud 206 in the set of training data set 214, the pre-trained computer vision neural network 204 processes each image in the corresponding set of images 202 to generate a respective target feature for each of a plurality of patches of the image. Each image can be divided into patches. Each patch is a region of the image. These patches can be mapped to points in the training point cloud. The patches can be mapped to points in the training cloud by projecting the points in the point cloud to camera pixels using a calibrated camera projection matrix in order to query pixel to point correspondence.

The pre-trained computer vision neural network 204 can be any appropriate type of machine learning model, e.g., a neural network model, or another type of machine learning model that is configured to process one or more images and generate features.

For example, the pre-trained computer vision neural network 204 can be a neural network that has been pre-trained using both images and text. The pre-trained computer vision neural network 204 can have been contrastively pre-trained using contrastive learning on a large multimodal data set. As a result of being contrastively pre-trained on a large multimodal dataset, the computer vision neural network 204 can produce image embeddings and text identifying the image embeddings that are more semantically similar and accurate than neural networks that are not contrastively pre-trained. Example architectures for the computer vision neural network include Segment Anything (Kirillov, Alexander, et al. “Segment anything.” arXiv preprint arXiv:2304.02643 (2023)), PaLI (Chen, Xi, et at “Pali A jointly-scaled multilingual language-image model” arXiv preprint arXiv:2209.06794 (2022)), ALIGN (Jia, Chao, et al “Scaling up visual and vision-language representation learning with noisy text supervision.” International conference on machine learning PMLR, 2021), and so on.

The target features can be feature representations that are ordered collections of numeric values, e.g., a matrix or vector of floating point or quantized values. The target features can be, for example, image embeddings generated by an image encoder (e.g., a ViT encoder or a convolutional encoder) of the pre-trained computer vision neural network 204.

For each training point cloud 206 in the set of training data set 214, the point cloud processing neural network 210 processes the training point cloud to generate respective features for each of a plurality of points in the training point cloud. The point cloud processing neural network 210 can be any appropriate type of machine learning model e.g., a neural network that is configured to process an input point cloud to generate a respective feature for each of the points in the point cloud. Example architectures include the neural network of Zhou, Yin, et al. “End-to-end multi-view fusion for 3d object detection in lidar point clouds.” Conference on Robot Learning. PMLR, 2020.

The respective features 212 can be feature representations that are ordered collections of numeric values, e.g., a matrix or vector of floating point or quantized values. The target features can be, for example, feature representations that represent features from a single view, e.g., a birds eye view or a perspective view, voxel features, or fused features that include both single view and voxel features.

For each training point cloud, the optimization system 214 trains the point cloud processing neural network 210 on a loss that includes a term that measures, for each of at least a subset of points in the point cloud, a difference (e.g., cosine similarity, L2 distance, and so on) 216 between the respective target feature 208 for the point and the respective feature 212 for the point.

Additionally, the point cloud processing neural network 210 can be further configured to process the respective features for each of the plurality of points to generate a task prediction for a machine learning task e.g., object detection, trajectory prediction, etc.

In some examples, after training the point cloud processing neural network 210 on the training data set 214, the training system 200 can train the point cloud processing neural network 210 on training data for the machine learning task.

In other examples, the training system 200 can simultaneously train the point cloud processing neural network 210 on the training data set 214 and on training data for the machine learning task.

In some other examples, the training system 200 can pre-train the point cloud processing neural network 210 on multiple different pretraining objectives e.g., target feature identification, multiple machine learning tasks, that include the objective computed using the training data set 214 described above prior to training the neural network on the training data for the machine learning task.

The training data for the machine learning task can include ground truth outputs for the machine learning task. The training system 200 can train the point cloud processing neural network using the target features 208 and the respective ground truth outputs. At inference, the point cloud processing neural network 210 can receive a new point cloud. The point cloud processing neural network 210 can process the new point cloud to generate a prediction for a machine learning task.

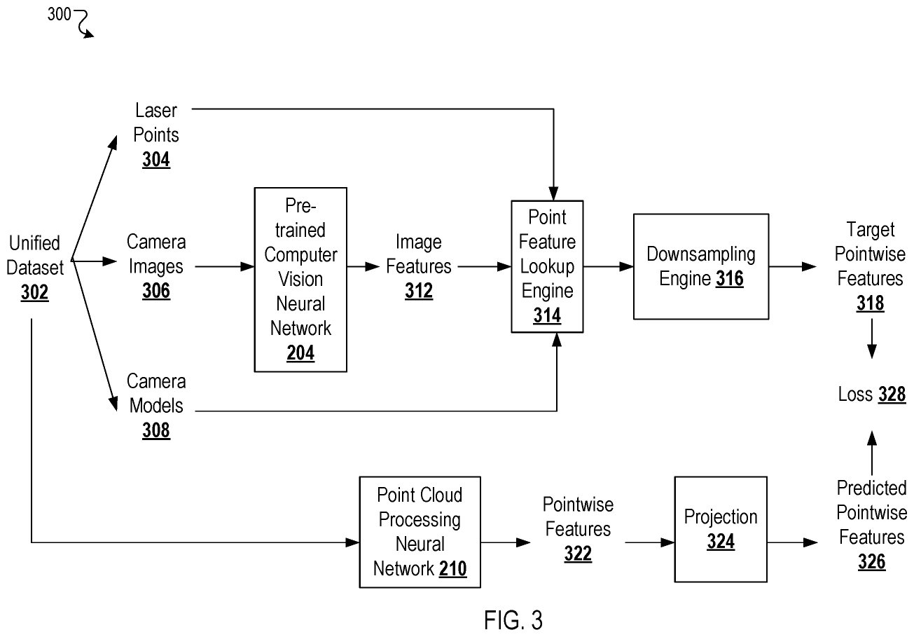

FIG. 3 shows an example training pipeline 300. The pipeline includes a pre-trained computer vision neural network 204, a point feature lookup engine 314, a down sampling engine 316, a point cloud processing neural network, and a projection layer 324.

The pipeline begins with a unified dataset 302 that includes, for each training example, laser points 304, camera images, 306, and camera models 308.

The laser points 304 are the points of a point cloud. The points can be generated, for example, by using LIDAR sensors. For example, each point in the point cloud can correspond to a reflection of laser light.

The camera images 306 are images captured by one or more camera sensors aboard the vehicle e.g., an SVC camera, an RGB camera etc. The images can include one or more images of the scene surrounding the vehicle at a point in time.

The camera models 308 map the pixels in the images 306 to laser points 304. The camera models 308 indicate which pixels in the image correspond to each laser point in the point cloud. The camera models 308 identify the pixels in the image and the points in the point cloud that correspond to the same real-world point. The camera models project some or all of 3D points in the point cloud onto a pixel in the image. The pixel that a particular laser point is projected to is selected as a projected pixel that corresponds to the laser point.

In some examples, the field of views of multiple cameras may overlap. A point may be projected onto one or more images that have overlaps. A point may be in the middle of an overlap and can be projected into two images. The camera models 308 can pick one image to map to by calculating the distance between the projected pixel in each image to the image center. The model can select the image that has a center closer to projected pixel.

The pre-trained computer vision neural network 204 processes the camera images 306 to generate image features 312. The image features 312 are of dimension K×Height×Width×D, where K is the number of cameras and D is the dimension of each feature.

The point feature lookup engine 314 processes the camera models 308 and the image features 312 to find the laser points that each image feature corresponds to. The down sampling engine 316 randomly selects a portion (i.e. 40%, 55%, 80% etc.) of points for which to select target features for. Each scene can have hundreds of thousands of points which results in a large feature map. The down sampling engine 316 down samples the points as directly using the feature map may be infeasible due to memory constraints. The target pointwise features 318 have dimension N′×D where N′ is less than N and N is the total number of points in the point cloud.

The point cloud processing neural network 320 processes the unified dataset 302 to generate pointwise features 322. The projection layer 324 processes the pointwise features to generate predicted pointwise features 326. The projection layer 324 can project the fused features to have N×D dimensions.

The training system trains the cloud point processing neural network to optimize a loss. The loss can be a cosine similarity loss that measures the similarity between the target pointwise features 318 and the pointwise features 322.

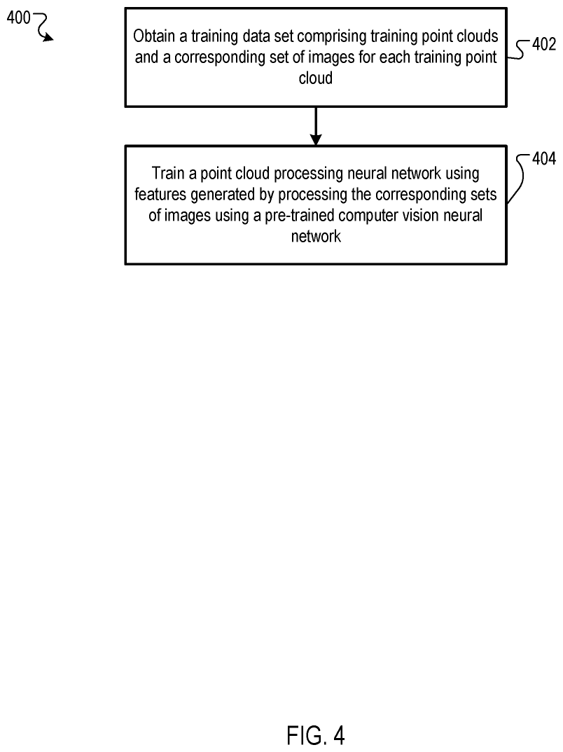

FIG. 4 is a flow diagram of an example process 400 for training a point cloud processing neural network. For convenience, the process 400 will be described as being performed by a system of one or more computers located in one or more locations. For example, a training system, e.g., the training system 200 of FIG. 2, appropriately programmed in accordance with this specification, can perform the process 400.

The system obtains a training data set (step 402). The training data set can include a plurality of training point clouds and, for each training point cloud, a corresponding set of images. Each training point cloud can represent a sensor measurement of a scene captured by one or more sensors.

Each training point cloud in the training data set is a collection of data points defined by a given coordinate system. For example, in a three-dimensional coordinate system, a point cloud can define the shape of some real or synthetic physical system, where each point in the point cloud is defined by three values representing respective coordinates in the coordinate system, e.g., (x, y, z) coordinates. As another example, in a three-dimensional coordinate system, each point in the point cloud can be defined by more than three values, wherein three values represent coordinates in the coordinate system and the additional values each represent a property of the point of the point cloud, e.g., an intensity of the point in the point cloud. Point cloud data can be generated, for example, by using LIDAR sensors or depth camera sensors. For example, each point in the point cloud can correspond to a reflection of laser light or other radiation transmitted in a particular direction by a sensor a vehicle.

The corresponding set of images for a training point cloud can include images captured by one or more camera sensors aboard the vehicle e.g., an SVC camera, an RGB camera etc. Each set of images can include one or more images of the scene surrounding the vehicle at a point in time. In some examples, the images in the sets of images can be captured by multiple cameras that capture an image of respective regions of the environment at the given point in time.

The system trains a point cloud processing neural network on the training data set using target features generated by a pre-trained computer vision neural network(step 404).

The point cloud processing neural network can be any appropriate type of machine learning model e.g., a neural network that is configured to process each image in the corresponding set of images to generate a respective target feature for each of a plurality of patches of the image. These patches can be mapped to points in the training point cloud.

The pre-trained computer vision neural network can be any appropriate type of machine learning model, e.g., a neural network model, or another type of machine learning model that is configured to process one or more images and generate features.

In some implementations, the pre-trained computer vision neural network can be a neural network that has been pre-trained using both images and text. In some implementations, the pre-trained computer vision neural network is a neural network that has been pre-trained jointly with a text processing neural network.

As a particular example, the computer vision neural network can be a test-prompted image segmentation neural network.

The target features can be feature representations that are generated by processing the corresponding sets of images using the pre-trained computer vision neural network. The feature representations can be ordered collections of numeric values, e.g., a matrix or vector of floating point or quantized values. The target features can be, for example, image embeddings generated by an image encoder (i.e., a ViT encoder) of the pre-trained computer vision neural network.

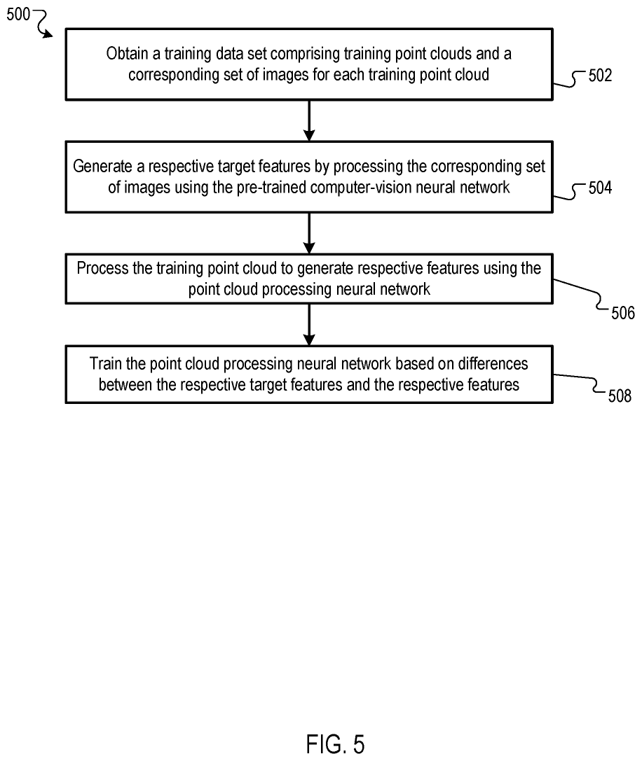

Training the point cloud processing neural network is described in further detail below with reference to FIG. 5.

FIG. 5 is a flow diagram of an example process 500 for training a point cloud processing neural network. For convenience, the process 500 will be described as being performed by a system of one or more computers located in one or more locations. For example, a training system, e.g., the training system 200 of FIG. 2, appropriately programmed in accordance with this specification, can perform the process 500.

The system obtains a training data set (step 502). The training data set can include a plurality of training point clouds and, for each training point cloud, a corresponding set of images.

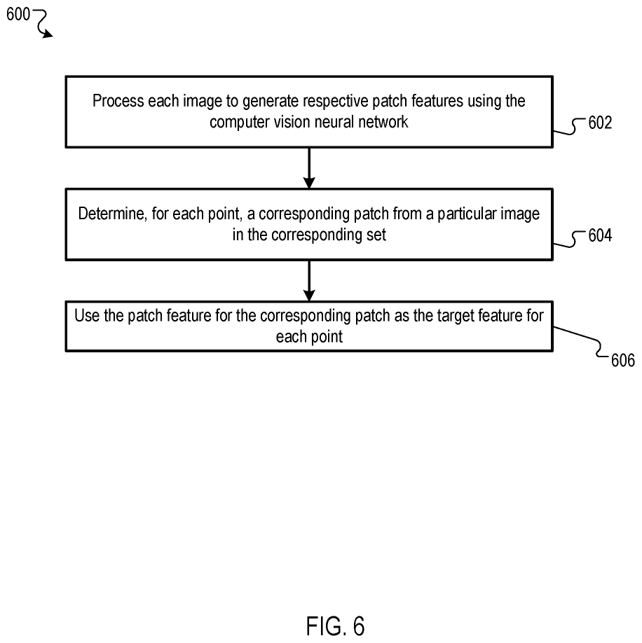

The system generates a respective target feature for each of a plurality of points from the training point cloud by processing the corresponding set of images using a pre-trained computer vision neural network (step 504). Generating a respective target feature for each of a plurality of points from the training point cloud is described in further detail below with reference to FIG. 6.

The system processes the training point cloud using the point cloud processing neural network to generate respective features of each of the plurality of points (step 506).

The respective features can be feature representations that are ordered collections of numeric values, e.g., a matrix or vector of floating point or quantized values. The target features can be, for example, feature representations that represent features from a single view, e.g., a birds eye view or a perspective view, voxel features, or fused features that include both single view and voxel features.

The system trains the point cloud processing neural network based on differences between the respective target features and the respective features for each of the plurality of points (step 508). The system trains the point cloud processing neural network on a on a loss that includes a term that measures, for each of at least a subset of points in the point cloud, a difference (e.g., cosine similarity, L2 distance, and so on) between the respective target feature for the point and the respective feature for the point. In some implementations, the point cloud processing neural network can be further configured to process the respective features for each of the plurality of points to generate a task prediction for a machine learning task e.g., object detection, trajectory prediction, etc.

In some examples, after training the point cloud processing neural network on the training data set, the system can train the point cloud processing neural network on training data for the machine learning task. In other examples, the training system can simultaneously train the point cloud processing neural network on the training data set and on training data for the machine learning task. In some examples, the training system can pre-train the point cloud processing neural network on multiple different pretraining objectives e.g., target feature identification, multiple machine learning tasks, etc.

FIG. 6 is a flow diagram of an example process 600 for generating a respective target feature for each of a plurality of points in a point cloud. For convenience, the process 600 will be described as being performed by a system of one or more computers located in one or more locations. For example, a training system, e.g., the training system 200 of FIG. 2, appropriately programmed in accordance with this specification, can perform the process 600.

The system can process each image in the corresponding set of images using the pre-trained computer vision neural network to generate, for each corresponding image, a respective patch feature for each of a plurality of patches in the image (step 602). The pre-trained computer vision neural network can divide each image in the set of corresponding images into a grid of patches. The pre-trained computer vision neural network can derive a patch feature for each patch in each image. The patch features can be, for example, image embeddings generated by an image encoder of the pre-trained computer vision neural network.

The system can determine, for each of the plurality of points, a corresponding patch from a particular one of the images in the corresponding set (step 604). The system can map each pixel in each of the images in the corresponding set of images to a point in the point cloud using a camera model. The system can determine a patch of pixels that corresponds to a particular point.

The system can use, as the target feature for each point, the patch feature for the corresponding patch in the particular image (step 606).

In some implementations, the system can down sample the patch features to determine the target features for the point cloud. The system can randomly select a portion (i.e. 40%, 55%, etc.) of points for which to select the corresponding patch features as target features.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a training data set comprising a plurality of training point clouds and, for each training point cloud, a corresponding set of images; and
training, on the training data set, a point cloud processing neural network that is configured to process an input point cloud comprising a plurality of points to generate a respective feature for each of the plurality of points, the training comprising, using, as target features for the point cloud processing neural network, features generated by processing the corresponding sets of images using a pre-trained computer vision neural network.

2. The method of claim 1, the training comprising, for each of the training point clouds:
generating a respective target feature for each of a plurality of points from the training point cloud by processing the corresponding set of images using the pre-trained computer vision neural network;
processing the training point cloud using the point cloud processing neural network to generate respective features of each of the plurality of points; and
training the point cloud processing neural network based on differences between the respective target features and the respective features for each of the plurality of points.

3. The method of claim 1, wherein the pre-trained computer vision neural network has been pre-trained using both images and text.

4. The method of claim 3, wherein the pre-trained computer vision neural network has been pre-trained jointly with a text processing neural network.

5. The method of claim 1, wherein the computer vision neural network is a text-prompted image segmentation neural network.

6. The method of claim 1, wherein the point cloud processing neural network is further configured to process the respective features for each of the plurality of points to generate a task prediction for a machine learning task.

7. The method of claim 6, further comprising:
after training the point cloud processing neural network on the training data set, training the point cloud processing neural network on training data for the machine learning task.

8. The method of claim 6, wherein the training data set comprises, for each of the plurality of point clouds, a respective ground truth output for the machine learning task, and wherein the training the point cloud processing neural network on the training data set comprises training using (i) the target features and (ii) the respective ground truth outputs.

9. The method of claim 2, wherein generating a respective target feature for each of a plurality of points from the training point cloud by processing the corresponding set of images using a pre-trained computer vision neural network comprises:
processing each image in the corresponding set of images using the computer vision neural network to generate, for each corresponding image, a respective patch feature for each of a plurality of patches in the image;
determining, for each of the plurality of points, a corresponding patch from a particular one of the images in the corresponding set; and
for each of the plurality of points, using, as the target feature for the point, the patch feature for the corresponding patch in the particular image.

10. The method of claim 9, further comprising down sampling the patch features in the particular image.

11. A method performed by one or more computers, the method comprising:
receiving a new point cloud; and
processing the new point cloud using a point cloud processing neural network to generate a prediction for a machine learning task, wherein the point cloud processing neural network has been trained by performing the respective operations of claim 1.

12. A system comprising one or more computers and one or more storage devices storing instructions that when executed by the one or more computers cause the one or computers to perform operations comprising:
obtaining a training data set comprising a plurality of training point clouds and, for each training point cloud, a corresponding set of images; and
training, on the training data set, a point cloud processing neural network that is configured to process an input point cloud comprising a plurality of points to generate a respective feature for each of the plurality of points, the training comprising, using, as target features for the point cloud processing neural network, features generated by processing the corresponding sets of images using a pre-trained computer vision neural network.

13. The system of claim 12, the training comprising, for each of the training point clouds:
generating a respective target feature for each of a plurality of points from the training point cloud by processing the corresponding set of images using the pre-trained computer vision neural network;
processing the training point cloud using the point cloud processing neural network to generate respective features of each of the plurality of points; and
training the point cloud processing neural network based on differences between the respective target features and the respective features for each of the plurality of points.

14. The system of claim 12, wherein the point cloud processing neural network is further configured to process the respective features for each of the plurality of points to generate a task prediction for a machine learning task.

15. The system of claim 14, wherein the operations further comprise:
after training the point cloud processing neural network on the training data set, training the point cloud processing neural network on training data for the machine learning task.

16. The system of claim 13, wherein generating a respective target feature for each of a plurality of points from the training point cloud by processing the corresponding set of images using a pre-trained computer vision neural network comprises:
processing each image in the corresponding set of images using the computer vision neural network to generate, for each corresponding image, a respective patch feature for each of a plurality of patches in the image;
determining, for each of the plurality of points, a corresponding patch from a particular one of the images in the corresponding set; and
for each of the plurality of points, using, as the target feature for the point, the patch feature for the corresponding patch in the particular image.

17. One or more non-transitory computer storage media storing instructions that when executed by one or more computers cause the one or more computers to perform operations comprising:
obtaining a training data set comprising a plurality of training point clouds and, for each training point cloud, a corresponding set of images; and
training, on the training data set, a point cloud processing neural network that is configured to process an input point cloud comprising a plurality of points to generate a respective feature for each of the plurality of points, the training comprising, using, as target features for the point cloud processing neural network, features generated by processing the corresponding sets of images using a pre-trained computer vision neural network.

18. The non-transitory computer storage media of claim 16, the training comprising, for each of the training point clouds:
generating a respective target feature for each of a plurality of points from the training point cloud by processing the corresponding set of images using the pre-trained computer vision neural network;
processing the training point cloud using the point cloud processing neural network to generate respective features of each of the plurality of points; and
training the point cloud processing neural network based on differences between the respective target features and the respective features for each of the plurality of points.

19. The non-transitory computer storage media of claim 16, wherein the point cloud processing neural network is further configured to process the respective features for each of the plurality of points to generate a task prediction for a machine learning task.

20. The non-transitory computer storage media of claim 17, wherein generating a respective target feature for each of a plurality of points from the training point cloud by processing the corresponding set of images using a pre-trained computer vision neural network comprises:
processing each image in the corresponding set of images using the computer vision neural network to generate, for each corresponding image, a respective patch feature for each of a plurality of patches in the image;
determining, for each of the plurality of points, a corresponding patch from a particular one of the images in the corresponding set; and
for each of the plurality of points, using, as the target feature for the point, the patch feature for the corresponding patch in the particular image.
